(19) United States
(12) Patent Application Publication
(10) Pub. No.: US 2023/0211879 A1
(43) Pub. Date: Jul. 6, 2023

(54) UNMANNED CARGO LIFT ROTORCRAFT

(71) Applicant: Bell Textron Inc., Fort Worth, TX (US)

(72) Inventors: Steven R. Ivans, Ponder, TX (US); Brent C. Ross, Flower Mound, TX (US); Mathew Chapdelaine, Fort Worth, TX (US); Berlin B. Benfield, Grapevine, TX (US)

(21) Appl. No.: 17/569,818

(22) Filed: Jan. 6, 2022

(51) Int. Cl. B64C 39/02; B64C 1/14; B64C 29/00

(52) U.S. Cl. CPC B64C 39/024; B64C 1/1415; B64C 29/0008; B64C 2201/024; B64C 2201/128

(57) ABSTRACT

A vertical takeoff and landing (VTOL) aircraft, including: a vehicle controller circuit programmed to operate the VTOL aircraft without an onboard human operator; a rotor system; an airframe; and an external cargo coupling to receive an external payload of at least approximately 300 pounds beneath the airframe.

### TECHNICAL FIELD

This specification relates generally to the field of rotary aircraft and more particularly, though not exclusively, to an unmanned cargo lift rotorcraft.

### BACKGROUND

Rotary aircraft, also known as rotorcraft, are a class of aircraft that use rotary blades for lift and/or forward flight. Rotorcraft may include helicopters, tiltrotor aircraft, and other similar aircraft that are powered by rotary systems. Rotorcraft may have electrical or mechanical drive systems and may be powered by fuel, such as petrochemical fuel or by batteries or a combination of the two, or other sources such as electrochemical, biochemical, photovoltaic, nuclear, or other fuel sources, or any combination thereof.

### SUMMARY

Rotary aircraft may be tasked with carrying large or irregular loads. For example, there exist large manned rotorcraft with an open cargo area that can be used to lift large loads. A large crate can be mounted within the cargo bay or a load can be carried in a sling configuration.

### BRIEF DESCRIPTION OF THE DRAWINGS

To provide a more complete understanding of the present disclosure and features and advantages thereof, reference is made to the following description, taken in conjunction with the accompanying FIGURES, in which like reference numerals represent like elements.

FIG. 1 is a perspective view illustrating an embodiment of an unmanned tandem airlift rotorcraft.

FIG. 2 is a side view of unmanned tandem airlift rotorcraft.

FIG. 3 is a side view illustration of an illustrative cargo configuration for an unmanned tandem airlift rotorcraft.

FIG. 4 is a side view illustration of unmanned tandem airlift rotorcraft in another cargo configuration.

FIG. 5 is a side view illustration of unmanned tandem airlift rotorcraft in yet another cargo configuration.

FIG. 6 is a side view illustration of unmanned tandem airlift rotorcraft in yet another cargo configuration.

FIG. 7 is a cutaway perspective view of selected elements of a rotorcraft.

FIG. 8 is a perspective view illustration of an alternative unmanned airlift rotorcraft.

FIG. 9 is a cutaway perspective view of a shipping option of a rotorcraft.

FIG. 10 is a perspective view illustration of a single rotor airlift rotorcraft.

FIGS. 11A and 11B illustrate a rotorcraft with a cargo sled configuration.

FIG. 12 is an example of a rigid cargo container figuration for rotorcraft.

FIG. 13 is an illustration of a detachable container configuration for rotorcraft.

FIG. 14 is an illustration of a large aerodynamic container configuration for rotorcraft.

FIG. 15 is an illustration of a large aerodynamic container configuration for rotorcraft.

FIG. 16 is a perspective view illustration of an armed configuration for rotorcraft.

FIG. 17 is a perspective view illustration of an alternative weapon configuration for rotorcraft.

FIG. 18 is a perspective view illustration of a sling load configuration for rotorcraft.

FIG. 19 is a block diagram illustration of selected elements of an unmanned rotorcraft.

### DETAILED DESCRIPTION

The following disclosure describes various illustrative embodiments and examples for implementing the features and functionality of the present disclosure. While particular components, arrangements, and/or features are described below in connection with various example embodiments, these are merely examples used to simplify the present disclosure and are not intended to be limiting. It will of course be appreciated that in the development of any actual embodiment, numerous implementation-specific decisions may be made to achieve the developer's specific goals, including compliance with system, business, and/or legal constraints, which may vary from one implementation to another. Moreover, it will be appreciated that, while such a development effort might be complex and time-consuming, it would nevertheless be a routine undertaking for those of ordinary skill in the art having the benefit of this disclosure.

While the making and using of various embodiments of the present disclosure are discussed in detail below, it should be appreciated that the present disclosure provides many applicable inventive concepts, which can be embodied in a wide variety of specific contexts. The specific embodiments discussed herein are merely illustrative and do not delimit the scope of the present disclosure. In the interest of clarity, not all features of an actual implementation may be described in the present disclosure.

In the present specification, reference may be made to the spatial relationships between various components and to the spatial orientation of various aspects of components as depicted in the attached drawings. However, as will be recognized by those skilled in the art after a complete reading of the present disclosure, the devices, components, members, apparatuses, etc. described herein may be positioned in any desired orientation. Thus, the use of terms such as “above,” “below,” “upper,” “lower,” “top,” “bottom,” or other similar terms to describe a spatial relationship between various components or to describe the spatial orientation of aspects of such components, should be understood to describe a relative relationship between the components or a spatial orientation of aspects of such components, respectively, as the components described herein may be oriented in any desired direction. When used to describe a range of dimensions or other characteristics (e.g., time, pressure, temperature) of an element, operations, and/or conditions, the phrase “between X and Y” represents a range that includes X and Y.

Further, as referred to herein in this specification, the terms “forward,” “aft,” “inboard,” and “outboard” may be used to describe relative relationship(s) between components and/or spatial orientation of aspect(s) of a component or components. The term “forward” may refer to a special direction that is closer to a front of an aircraft relative to another component or component aspect(s). The term “aft” may refer to a special direction that is closer to a rear of an aircraft relative to another component or component aspect(s). The term “inboard” may refer to a location of a component that is within the fuselage of an aircraft and/or a spatial direction that is closer to or along a centerline of the aircraft relative to another component or component aspect(s), wherein the centerline runs in a between the front and the rear of the aircraft. The term “outboard” may refer to a location of a component that is outside the fuselage of an aircraft and/or a special direction that farther from the centerline of the aircraft relative to another component or component aspect(s).

Still further, the present disclosure may repeat reference numerals and/or letters in the various examples. This repetition is for the purpose of simplicity and clarity and does not in itself dictate a relationship between the various embodiments and/or configurations discussed.

### Overview

One example of VTOL aircraft is a helicopter, which is a rotorcraft having one or more rotors that provide vertical lift and forward thrust to the aircraft. Helicopter rotors not only enable hovering and vertical takeoff and vertical landing, but also enable forward, aftward, and lateral flight. These attributes make helicopters highly versatile for use in congested, isolated or remote areas where fixed-wing aircraft may be unable to take off and land. Helicopters, however, typically lack the forward airspeed of fixed-wing aircraft.

A tiltrotor is another example of a VTOL aircraft. Tiltrotor aircraft utilize tiltable rotor systems that may be transitioned between a forward thrust orientation and a vertical lift orientation. The rotor systems are tiltable relative to one or more fixed wings such that the associated proprotors have a generally horizontal plane of rotation for vertical takeoff, hovering, and vertical landing and a generally vertical plane of rotation for forward flight, or airplane mode, in which the fixed wing or wings provide lift. In this manner, tiltrotor aircraft combine the vertical lift capability of a helicopter with the speed and range of fixed-wing aircraft. Yet another type of VTOL aircraft is commonly referred to as a “tail-sitter.” As the name implies, a tail-sitter takes off and lands on its tail, but tilts horizontally for forward flight.

VTOL aircraft may be manned or unmanned. An unmanned aerial vehicle (“UAV”), also commonly referred to as a “drone,” is an aircraft without a human pilot aboard. UAVs may be used to perform a variety of tasks, including filming, package delivery, surveillance, and other applications. A UAV typically forms a part of an unmanned aircraft system (“UAS”) that includes the UAV, a ground-based controller, and a system of communication between the vehicle and controller.

Known cargo aircraft are generally manned. However, innovations in unmanned aircraft design have made it possible for an autonomous or semi-autonomous remotely controlled aircraft to provide many of the functions of manned aircraft. One advantage of using an unmanned aircraft for cargo loads is that the cargo capacity of the aircraft is not reduced by the weight of the pilot. For example, if an average human pilot weighs approximately 200 pounds, then the cargo capacity of the aircraft is reduced by 200 pounds.

Advances in composite materials, carbon fiber, and nano materials have also made it possible to manufacture sturdy rotorcraft that are relatively lightweight compared to older systems that are built of steel or aluminum.

The present specification provides various embodiments of a rotorcraft that may be used for airlift operations. Although these rotorcraft may be large — and, in various embodiments, may be as large as necessary to meet a particular demand — some examples may also be relatively small. For example, embodiments of rotorcraft described herein may be designed with a form factor that can be stowed in a standard 20-foot ISO shipping container (e.g., an intermodal shipping container) with the rotors removed or in a folded configuration. This can make it possible to ship the rotorcraft to many locations via various transport mechanisms.

Because the rotorcraft described are unmanned rotorcraft, they need not carry the mass of a human pilot. This means that a relatively small rotorcraft, such as one that can be folded into an ISO shipping container, may still have a usable payload capacity on the order of approximately 300 pounds. Larger rotorcraft may be built that do not fit in a modular shipping container, that they may have a larger cargo capacity. Other rotorcraft may also be built to fit other standard sizes of shipping containers. For example, standard shipping containers are 8 feet wide but may have a length of 20 to 40 feet. Thus, embodiments may be built that fit a 20-foot shipping container while other embodiments may fit a 40-foot shipping container. An embodiment that fits a 40-foot shipping container may have greater cargo capacity than an embodiment that fits a 20-foot shipping container. Furthermore, some embodiments may be designed to fit a 6-foot tall shipping container rather than an 8-foot tall shipping container.

The rotorcraft illustrated herein may have various rotor configurations. In one illustration, the rotorcraft includes a tandem rotor configuration. The tandem rotor configuration provides the lift of two separate sets of rotors and also eliminates the need for a traditional tail with a tail rotor to provide antitorque drive. The two rotors together work to keep the aircraft on station and controllable and provide extra lift to increase the cargo capacity. Another embodiment illustrates a single rotor aircraft with a traditional tail rotor. Various advantages may be realized by the various configurations. Furthermore, there are illustrated herein various examples of payloads that may be used with the illustrated airlift rotorcraft.

### DESCRIPTION OF THE DRAWINGS

A system and method for providing predictive preconditioning of an electric aircraft battery system will now be described with more particular reference to the attached FIGURES. It should be noted that throughout the FIGURES, certain reference numerals may be repeated to indicate that a particular device or block is referenced multiple times across several FIGURES. In other cases, similar elements may be given new numbers in different FIGURES.

Neither of these practices is intended to require a particular relationship between the various embodiments disclosed. In certain examples, a genus or class of elements may be referred to by a reference numeral (“widget 10”), while individual species or examples of the element may be referred to by a hyphenated numeral (“first specific widget 10-1” and “second specific widget 10-2”).

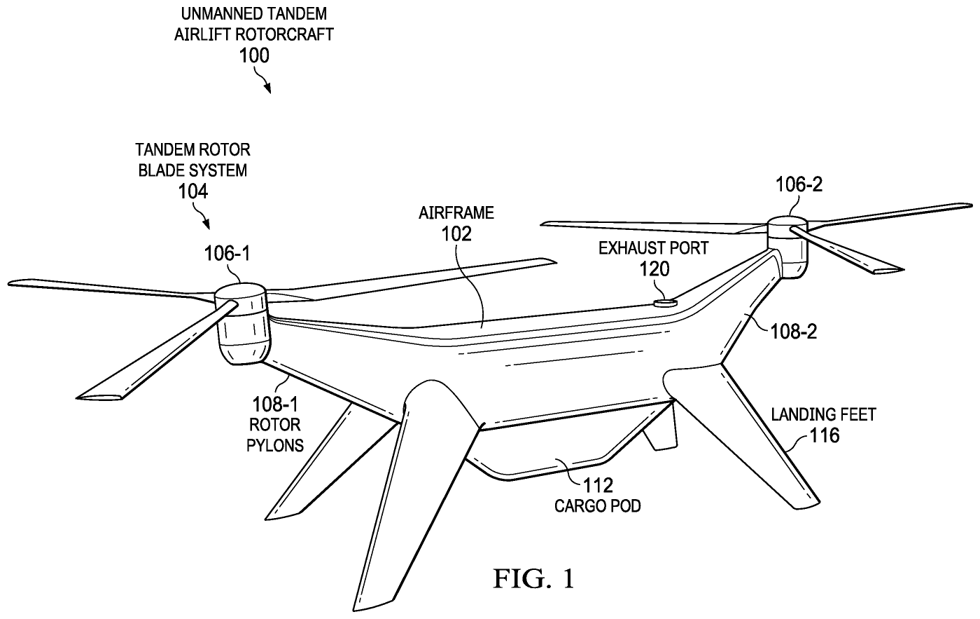

FIG. 1 is a perspective view illustrating an embodiment of an unmanned tandem airlift rotorcraft 100. Unmanned tandem airlift rotorcraft 100 includes an airframe 102. Airframe 102 may provide the structural support for the aircraft and may also provide an enclosure for operational complements. Airframe 102 may be manufactured, for example, from a composite material ora nano material which may enable airframe 102 have adequate structural integrity without being heavy.

Unmanned tandem airlift rotorcraft 100 includes a tandem rotor blade system 104 which includes two rotor assemblies 106. Rotor assemblies 106 in this illustration are located at the fore and aft of aircraft 100 and advantageously provide stability and torque control for the aircraft. Tandem rotor blade system 104 may also provide a variable center of gravity for rotorcraft 100. For example, if a load shifts or if its center of gravity is somewhat off-center, tandem rotor blade system 104 may adjust by applying additional torque to one rotor 106 or the other. This helps to keep the aircraft stable during flight.

Rotor blades 106-1 and 106-2 may be mounted on rotor pylons 108-1 and 108-2, respectively. In this example, rotor pylons 108 are provided with a thin armature and aerodynamic design. This may help to prevent download on rotor pylons 108 when rotors 106 are operating. In some existing aircraft, the rotors may be mounted directly above the airframe, which provides a substantial download force on the airframe when the rotors are operational. However, in this configuration, rotor pylons 108 extend rotors 106 away from airframe 102 and include an aerodynamic design that provides a low profile with respect to rotors 106. This helps to prevent substantial download forces on the airframe 102.

A cargo pod 112 may be mounted below rotorcraft 100. Cargo pod 112 may be mounted via hooks, a quick release system, or a standard modularized system that accepts many different kinds of cargo containers and form factors. Alternatively, a cargo hook could be mounted to one or multiple points on cargo pod 112, and one or a plurality of mounting points could be provided under airframe 102 to receive cargo pod 112.

Landing feet 116 are also illustrated. Some existing aircraft may have landing skids or wheels. However, in some examples, the small form factor and light design of rotorcraft 100 makes it possible to provide static landing feet 116. One advantage of having four discrete landing feet 116 versus landing skids is that landing skids include a lateral bar between the struts. This lateral bar may, in some cases, partially block access to cargo pod 112. Thus, it may be preferable to have landing feet 116 that do not block access to cargo pod 112. However, other embodiments may have landing skids or landing wheels as in some existing aircraft.

In some cases, landing feet 116 could provide a modular system, such that a landing skid, landing skis, or landing wheels could be modularly affixed to landing feet 116 to provide different landing configurations.

Also visible here is an exhaust port 120. Exhaust port 120 may be used to exhaust engine gases in the case that a mechanical engine is used versus an electric motor. If an electric motor is used without a petrochemical fuel source, then exhaust port 120 may be unnecessary.

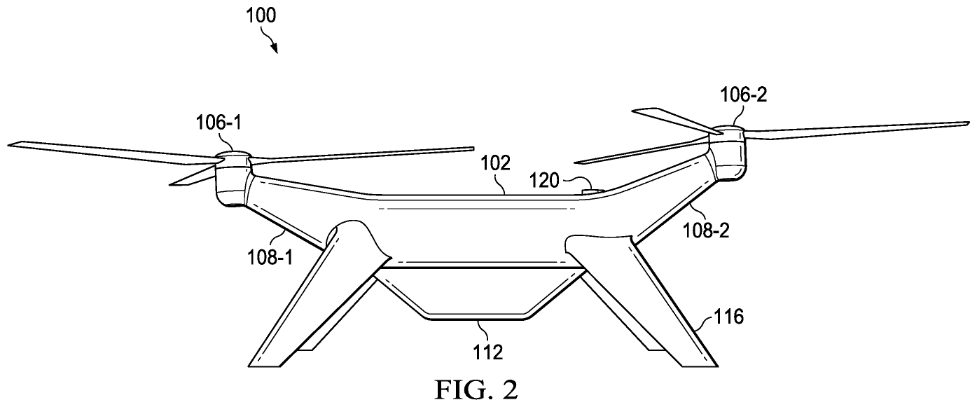

FIG. 2 is a side view of unmanned tandem airlift rotorcraft 100. Shown in this side view are the same airframe 102, rotors 106-1, 106-2, rotor pylons 108-1, 108-2, aircraft feet 116, cargo pod 112, and exhaust port 120.

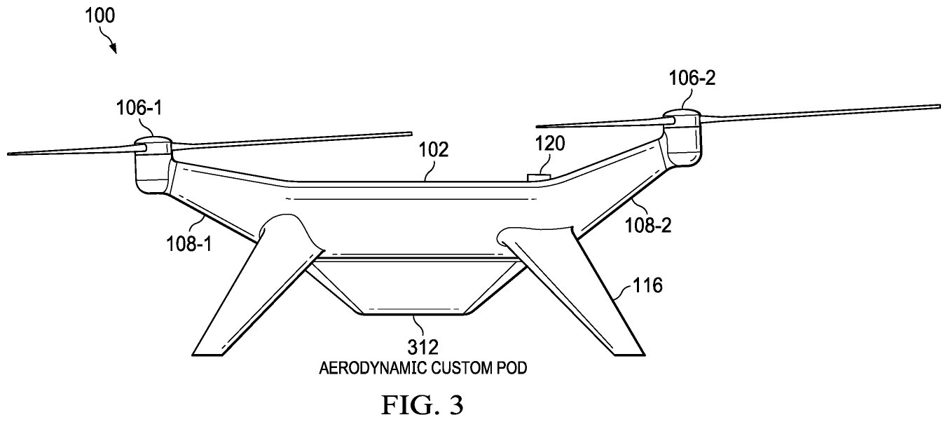

FIG. 3 is a side view illustration of an illustrative cargo configuration for an unmanned tandem airlift rotorcraft 100. Illustrated in FIG. 3 are airframe 102, rotors 106-1, 106-2, rotor pylons 108-1, 108-2, landing feet 116, and exhaust port 120.

In this configuration, rotorcraft 100 is provided with an aerodynamic custom pod 312. Aerodynamic custom pod 312 may be a custom pod manufactured of materials, such as carbon fiber, composite materials, nano materials, or other similar material that is selected specifically to work with the configuration of rotorcraft 100. Aerodynamic custom pod 312 also has a shape that is designed to be aerodynamic to reduce the drag on rotorcraft 100. Aerodynamic custom pod 312 may be accessible from front, rear, or side hatches. Alternatively, aerodynamic custom pod 312 could have an open top that fits snugly against the belly of rotorcraft 100. Aerodynamic custom pod 312 could then be filled from the top until it is level with the top and may then be secured to rotorcraft 100 via mounting hooks, quick release, or similar.

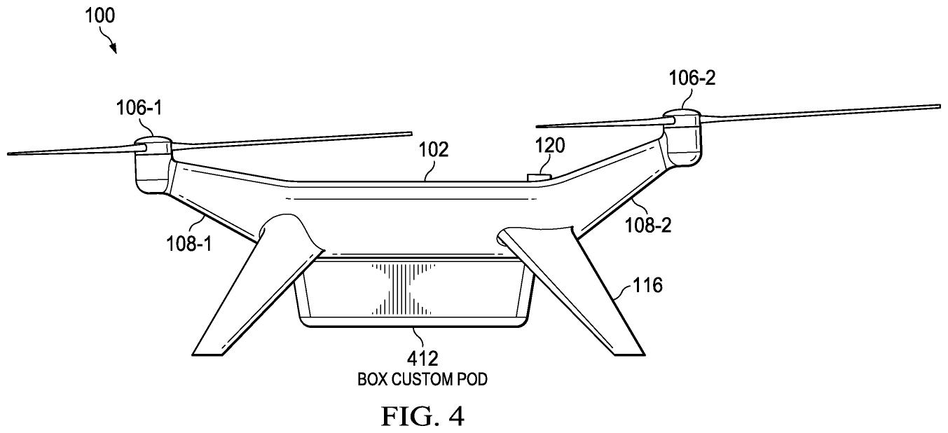

FIG. 4 is a side view illustration of unmanned tandem airlift rotorcraft 100 in another cargo configuration. As in previous illustrations, there is shown here rotors 106-1, 106-2, rotor pylons 108-1, 108-2, airframe 102, landing feet 116, and exhaust port 120.

In this illustration, rotorcraft 100 is provided with a box style custom pod 412. Box style custom pod 412 may have somewhat greater cargo capacity than aerodynamic pod 312 of FIG. 3. However, box pod 412 may not be as aerodynamic and thus may create additional drag. The use of box pod 412 versus aerodynamic pod 312 of FIG. 3 may be a design decision. Furthermore, rotorcraft 100 may be configured to receive any of the various cargo configurations disclosed herein with a uniform mounting system that can receive various different types of cargo pods or containers. Thus, any of the cargo configurations illustrated herein should be understood to not be mutually exclusive.

As with custom pod 312, custom pod 412 may be made of a composite material, nano material, carbon fiber, lightweight metal, or other material selected for light weight and durability and to be compatible with rotorcraft 100.

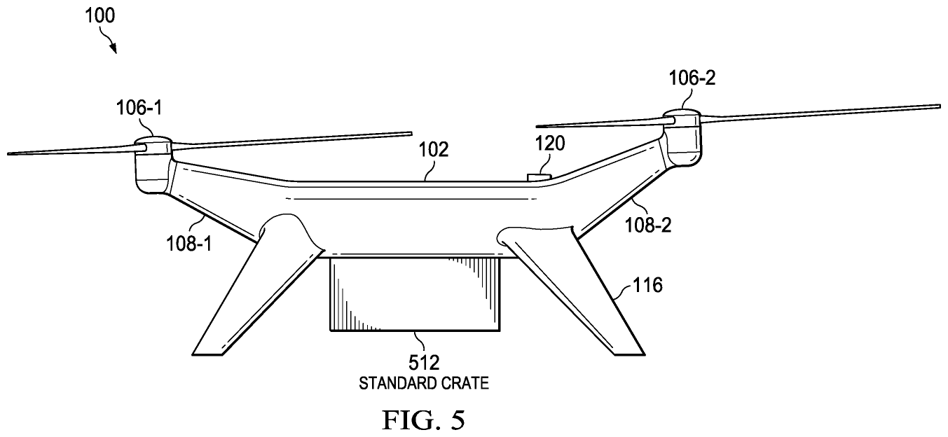

FIG. 5 is a side view illustration of unmanned tandem airlift rotorcraft 100 in yet another cargo configuration. As before, there is shown herein airframe 102, rotors 106-1, 106-2, rotor pylons 108-1, 108-2, landing feet 116, and exhaust port 120.

In this configuration, rotorcraft 100 is configured to carry a standard crate 512. Standard crate 512 should be understood to stand for a class of crates or containers that are not designed to work specifically with rotorcraft 100. Rather, they may be standard shipping crates or cargo containers and, in some cases, may be provided with straps, mounting points, or other adapters so that they may mount to rotorcraft 100.

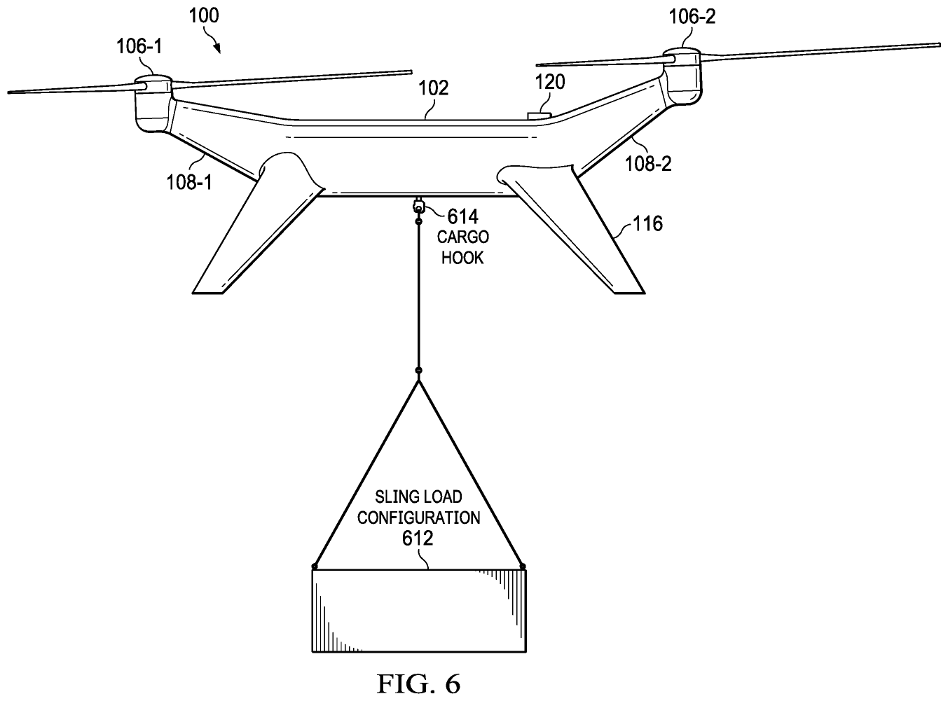

FIG. 6 is a side view illustration of unmanned tandem airlift rotorcraft 100 in yet another cargo configuration. As before, there is shown herein airframe 102, rotors 106-1, 106-2, rotor pylons 108-1, 108-2, landing feet 116, and exhaust port 120. In this case, a sling load configuration 612 is affixed to rotorcraft 100 via a cargo hook 614. Cargo hook 614 may use one or more straps or slings to contain the cargo, which may allow for the lifting of cargo loads that are of unusual sizes, shapes, or configurations that would not fit directly in the cargo area of rotorcraft 100.

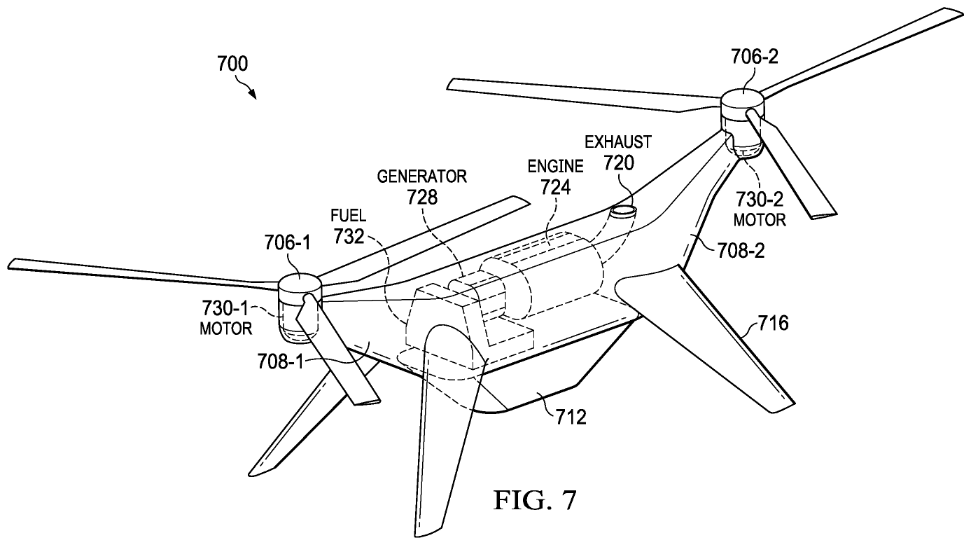

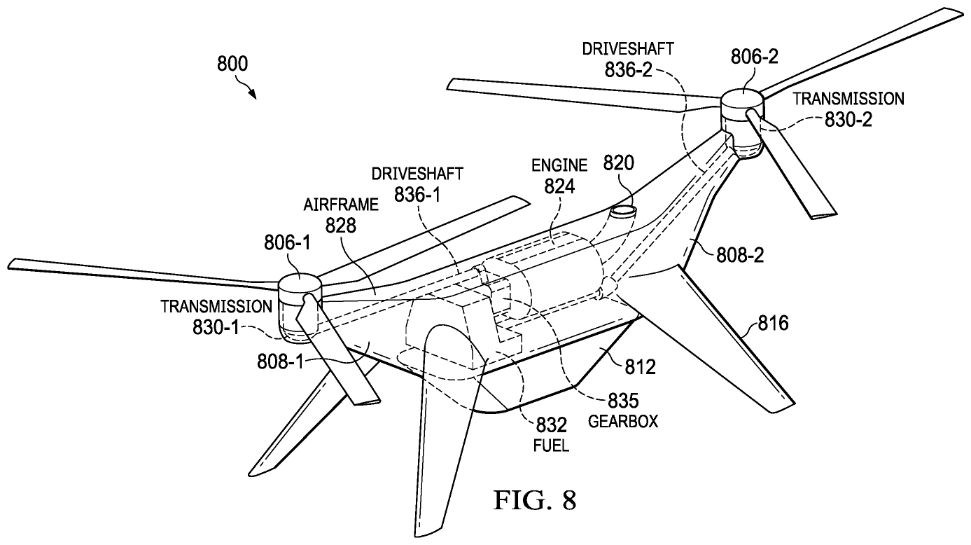

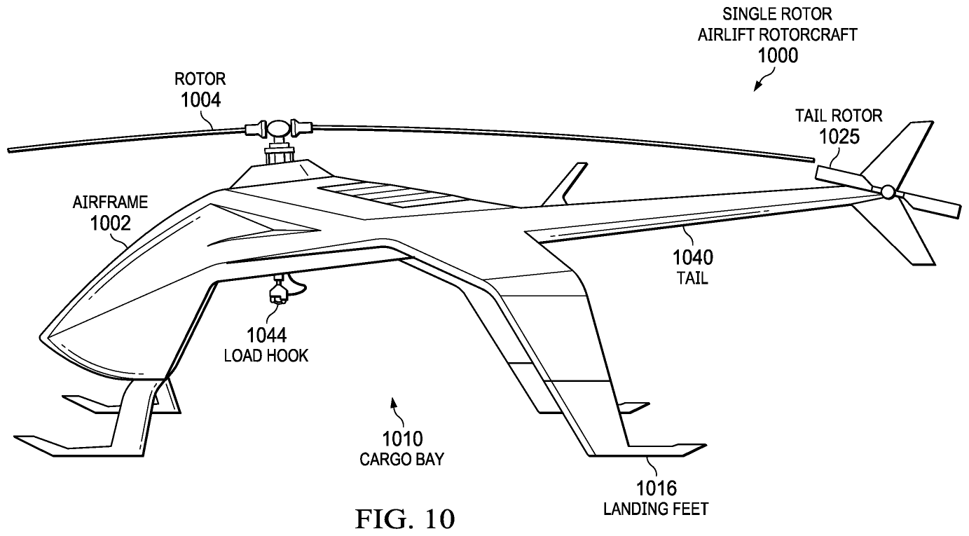

FIG. 7 is a cutaway perspective view of selected elements of a rotorcraft 700. Rotorcraft 700 may be an example of any of the other rotorcraft illustrated herein. In particular, rotorcraft 700 and rotorcraft 800 of FIG. 8 are provided as illustrations of various drive configurations that may be used herein. Rotorcraft 700 may thus be a tandem rotorcraft or a single rotorcraft as illustrated in FIGS. 10 through 18 below.

Mechanically, rotorcraft 700 may substantially match with rotorcraft 100 of FIG. 1. For example, rotorcraft 700 includes an airframe to provide structural elements, including mounting pylons 708-1 and 708-2. In this illustration, tandem rotor blades 706-1 and 706-2 are mounted respectively to pylons 708-1 and 708-2. Note, however, that a single rotor configuration is also possible. A set of landing feet 716 are also provided, and rotorcraft 700 may carry a cargo payload 712.

In this example, an engine 724 is provided as a power source for rotorcraft 700. Engine 724 may vent via exhaust port 720.

To save on weight and complexity, engine 704 may not directly drive rotors 706-1, 706-2. Rather, engine 724 may directly drive a generator 728. This enables generator 728 to indirectly draw from fuel 732, which may be, for example, a petrochemical fuel. Generator 728 may then electrically drive motors that actuate rotors 706-1 and 706-2. Advantageously, this configuration provides the longevity of flight of a traditional fueled aircraft but may save on space by not requiring driveshafts to rotors 706-1 and 706-2. Rather, simple electrical wires may be provided that run through mounting pylons 708 to their respective rotors 706. These wires may then drive motors 730-1 and 730-2 respectively, which then turn rotors 706-1 and 706-2.

With the use of relatively small electrical wires to power motors 730, mounting pylons 708 may be smaller than they would need to be for a mechanical driveshaft.

In other embodiments, a purely electrical system could be provided. For example, instead of engine 724 and fuel 732, the system could be provided with a battery bank of rechargeable batteries, such as lead acid batteries, lithium-ion batteries, or similar. Batteries tend to be less fuel dense than petrochemical fuel sources, and thus a purely battery-powered rotorcraft 700 may have less flight longevity than the hybrid configuration illustrated here.

Other configurations are also possible, including those using alternative fuel sources, such as electrochemical, biochemical, photovoltaic, nuclear, or other fuel sources, or any combination thereof.

FIG. 8 is a perspective view illustration of an alternative unmanned airlift rotorcraft 800. Unmanned airlift rotorcraft 800 similarly may be a tandem or single rotor configuration. As in other examples, rotorcraft 800 includes in airframe 828, an optional tandem drive system, including rotors 806-1 and 806-2 mounted on respective mounting pylons 808-1 and 808-2. Rotorcraft 800 may carry a cargo payload 812 and may be provided with landing feet 816.

In this example, as opposed to the hybrid configuration of FIG. 7, rotorcraft 800 may be provided with a purely mechanical fit configuration. In this case, an engine 824 draws from fuel 832, which may be, for example, a petrochemical or other chemical fuel. Engine 824 ports exhaust through exhaust port 820.

In this nonhybrid configuration or purely mechanical configuration, engine 824 drives driveshafts 836-1 and 836-2 through gearbox 835 to reduce RPM. Driveshafts 836 turn respective transmissions 830-1 and 830-2, which then turn respective rotors 806-1 and 806-2. Transmissions 830-1 and 830-2 provide additional RPM reduction as well as changing the direction.

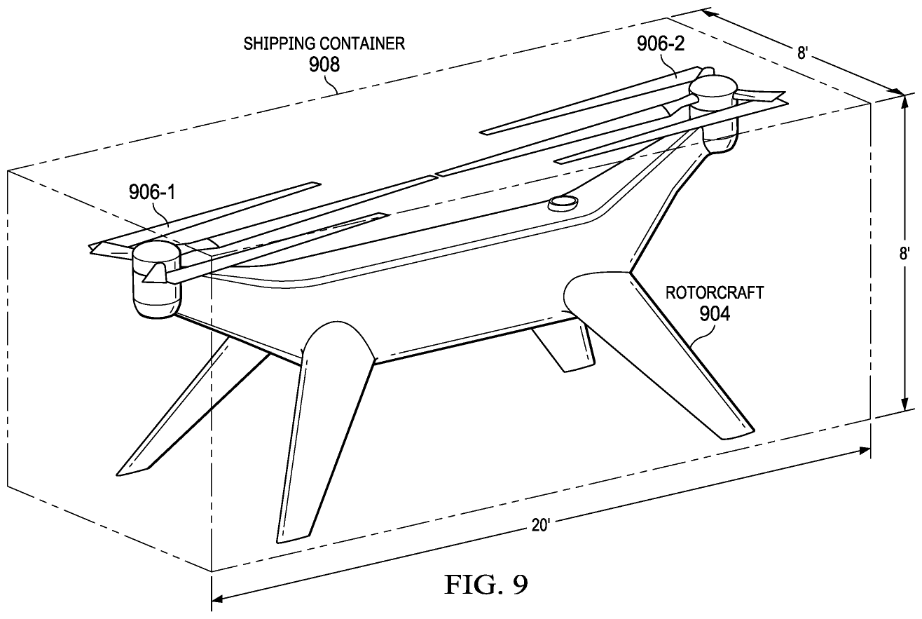

FIG. 9 is a cutaway perspective view of a shipping option of a rotorcraft 904. In this illustration, rotorcraft 904 has dimensions and form factor such that it may be stowed in a standard ISO intermodal shipping crate 908. Shipping crate 908 in this illustration has dimensions of 20-foot long, 8-foot tall, and 8-foot wide. Although there are many different dimensions of shipping containers, approximately 90 percent of shipping containers worldwide have this common configuration. Shipping container 908 may have rotorcraft 904 stowed therein. Rotorcraft 904 includes foldable rotor blades 906-1 and 906-2. This folding configuration may be similar to the folding rotor blades of the Bell V-22 Osprey aircraft. However, the V-22 Osprey aircraft includes a robust electrical drive system to fold the rotors. While such a robust electrical system could be used, it is also possible to provide a simpler system, such as the use of a rod pin, cotter pin, or other securing means to secure the rotors in their extended configuration. When rotorcraft 904 is to be stowed, the securing means may be removed, the rotors manually folded, and rotorcraft 900 store may be stowed in shipping container 908 for transportation.

As discussed above, rotorcraft 904 may have dimensions to fit within shipping container 908 having the given dimensions. Other shipping containers may have different dimensions. For example, some shipping containers are 8-foot tall, 8-foot wide, and 40-foot long. Rotorcraft 904 may have dimensions to sit within such a shipping container. Rotorcraft 904 may also be dimensioned to fit within a 20-foot long, 6-foot high, and 8-foot wide shipping container. Rotorcraft 904 may also have dimensions to fit in a 40-foot long, 6-foot high, and 8-foot wide shipping container. Alternatively, rotorcraft 904 may be designed to fit within any other standard shipping container or crating configuration.

FIG. 10 is a perspective view illustration of a single rotor airlift rotorcraft 1000. Single rotor airlift rotorcraft 1000 is provided as an alternative embodiment that performs many of the same functions as tandem rotor airlift rotorcraft 1 of FIG. 1. Single rotor airlift rotorcraft 1000 may have different advantages and disadvantages as compared to tandem rotor airlift rotorcraft 1000.

Rotorcraft 1000 includes an airframe 1002, which provides mechanical support for the aircraft, and also provides a casing for internal components. Airframe 1002 may be made of any suitable material, including a composite material, a nano material, carbon fiber, lightweight metal, or similar.

Rotorcraft 1000 includes a single rotor assembly 1004, which provides a plurality of rotor blades such as two blades, three blades, four blades, five blades, six blades, or seven blades in various embodiments.

Rotorcraft 1000 includes an open cargo bay 1010. Open cargo bay 1010 may be configured to receive various payloads or cargo configurations as illustrated throughout. Cargo bay 1010 may include a load hook 1044, which may be used, for example, to secure loads to rotorcraft 1000, a load head 1044 may also be used in the case of sling load configuration to carry a load beneath rotorcraft 1000.

Because rotorcraft 1000 includes a single rotor 1004, a tail 1040 and tail rotor 1025 may also be provided to provide torque stability to rotorcraft 1000.

Rotorcraft 1000 includes a set of landing feet 1012. Landing feet 1012 may be discrete landing feet, skids, wheels, skis, or another configuration. In this illustration, landing feet 1012 are illustrated as demi-skids, with skids extending outward towards the fore and aft of rotorcraft 1000, but not extending into and obstructing cargo bay 1010. This may help to provide easier access to cargo bay 1010. Landing feet 1012 could also be configured to modularly receive different types of landing gear, such as feet, skids, wheels, skis, pontoons, or similar.

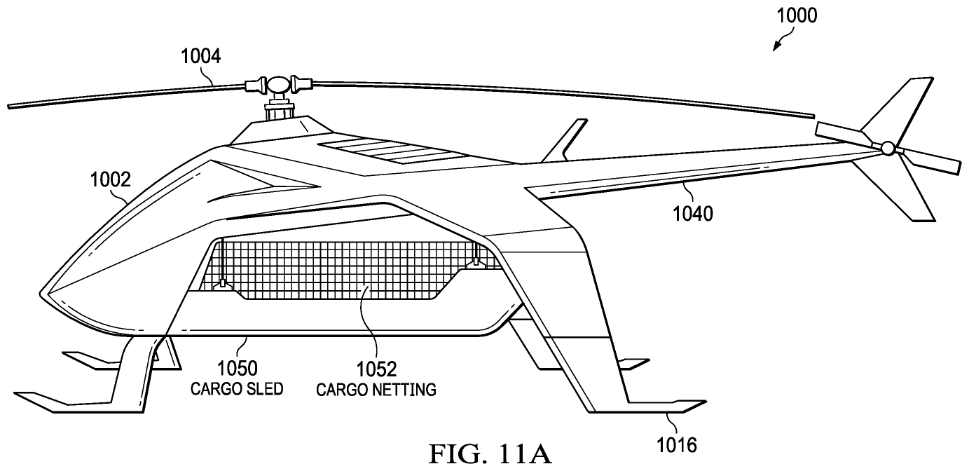

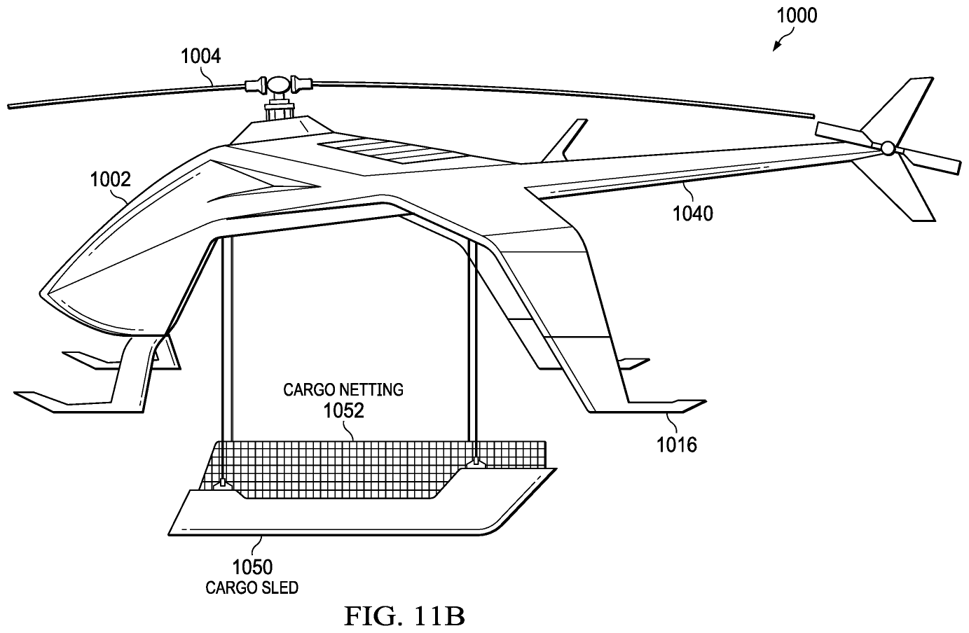

FIGS. 11A through 18 illustrate example cargo configurations for rotorcraft 1000. In each of FIGS. 11A through 18, rotorcraft 1000 is illustrated with airframe 1002, a rotor 1004, a tail 1040, and feet 1016. The different cargo configurations illustrated are not mutually exclusive of one another, and the same rotorcraft 1000 could be configured to receive any of the illustrated cargo configurations. In other embodiments, various modifications of rotorcraft 1000 could be made to specialize rotorcraft 1000 for a particular cargo configuration.

FIGS. 11A and 11B illustrate a rotorcraft 1000 with a cargo sled configuration. In FIG. 11A, cargo sled 1050 is raised, while in FIG. 11B cargo sled 1050 is lowered. Cargo sled 1050 may be affixed to the underside of rotorcraft 1000. As illustrated, cargo sled 1050 may include open or semi-open sides for easier loading and unloading. Furthermore, cargo sled 1050 could be provided with various mount points such as at the four upper corners of cargo sled 1050, which could be affixed to winch lines provided at appropriate points within the cargo bay of rotorcraft 1000. Thus, rotorcraft 1000 may raise and lower cargo sled 1050 as illustrated in FIG. 11B. In a lowered configuration, cargo sled 1050 may be even more accessible and thus easier to load. Once cargo sled 1050 is fully loaded, wenches may draw cargo sled 1050 up into the cargo bay of rotorcraft 1000. In some cases, cargo netting 1052 may be provided as a soft enclosure to keep objects from falling out of cargo sled 1050. Cargo netting 1052 may be preferable in some applications to hard sides, as it is more pliable and easier to work with. Furthermore, cargo netting 1052 may be removable for appropriate applications.

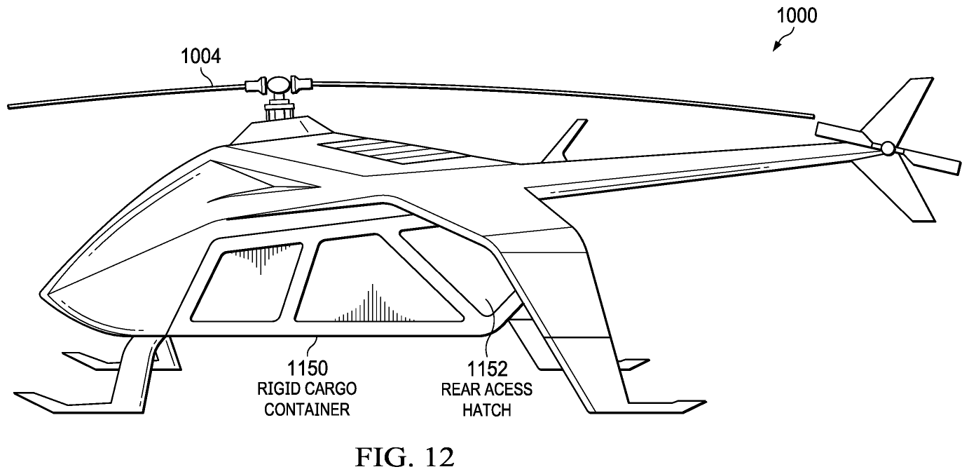

FIG. 12 is an example of a rigid cargo container figuration for rotorcraft 1000. In this configuration, rotorcraft 1000 has a rigid cargo container 1150, which may be mounted in a permanent or semi-permanent configuration to the cargo bay area of rotorcraft 1000. As with cargo sled 1052 or 1050 of FIG. 11A, rigid cargo container 1150 could also raise or lower on wenches. In an illustrative embodiment, rigid cargo container 1150 includes a rear access hatch 1152, which may be lowered similar to the hatch on the rear bed a pickup truck. This can provide rear access to rigid cargo container 1150, such as for loading and unloading. Thus, rigid cargo container 1150 could be mounted as a fixture to rotorcraft 1000 and need not be frequently removed. In some cases, rigid cargo container 1150 is a permanent feature of rotorcraft 1000.

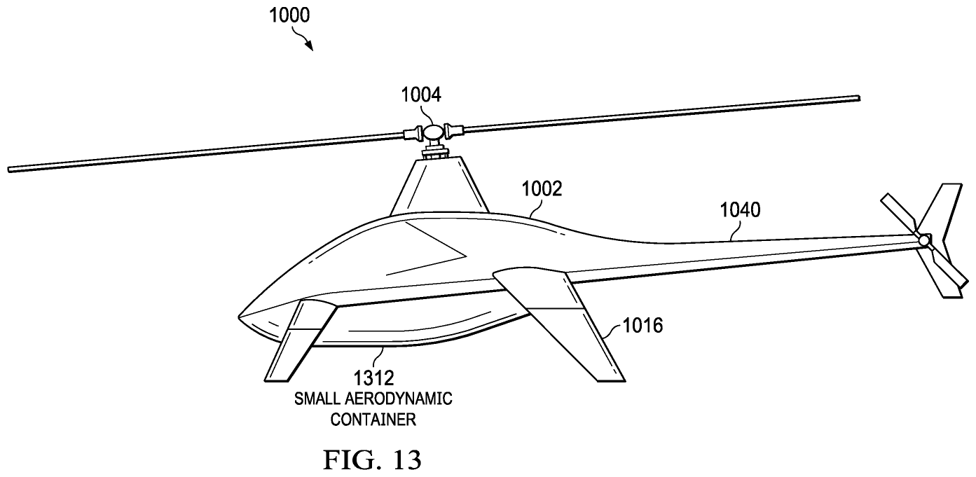

FIG. 13 is an illustration of a detachable container configuration for rotorcraft 1000. In the example of FIG. 13, rotorcraft 1000 has affixed thereto a small aerodynamic container 1312. Small aerodynamic container 1312 may be substantially conformal to the underbelly of rotorcraft 1000 and may be configured with a low profile. Small aerodynamic container 1312 is configured to either not protrude from the underbelly of rotorcraft 1000 or to protrude only slightly. Small aerodynamic container 1312 may be permanently or semi-permanently affixed to rotorcraft 1000 or could be raised and lowered on wenches. Furthermore, small aerodynamic container could have openings in the bottom, top, sides, or rear for loading and unloading. Small aerodynamic container may be constructed of materials, such as composites, nano materials, carbon fiber, lightweight metals, or other material selected specifically to work with rotorcraft 1000.

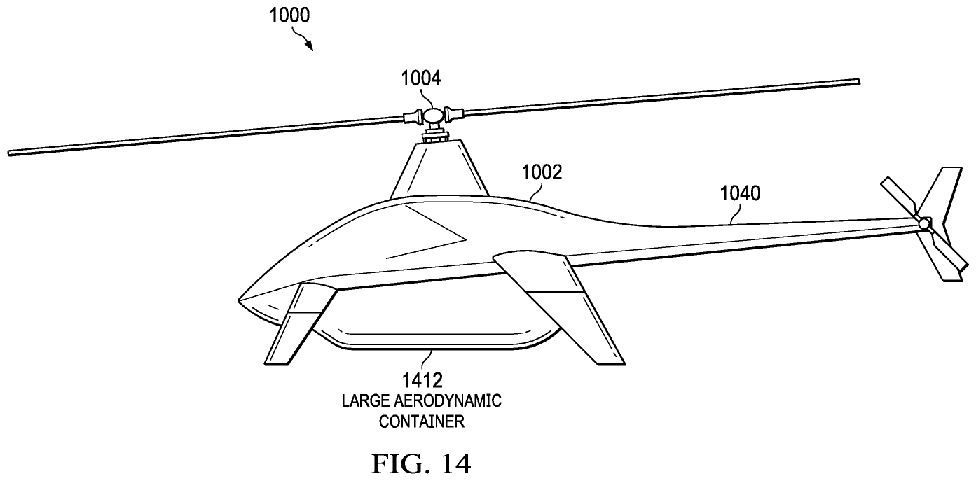

FIG. 14 is an illustration of a large aerodynamic container configuration for rotorcraft 1000. In this example, rotorcraft 1000 has a large aerodynamic container 1412 affixed to the bottom thereof. Large aerodynamic container 1412 may be permanently or semi-permanently affixed to the underside of rotorcraft 1000 or may be raised and lowered as necessary. Large aerodynamic container 1412 may be constructed of materials, such as composites, nano materials, carbon fiber, lightweight metals, or other material selected specifically to work with rotorcraft 1000.

Thus, large aerodynamic container 1412 may be designed specifically to work with rotorcraft 1000. Large aerodynamic container 1412 is less aerodynamic than small aerodynamic container 1312 of FIG. 13 but may have greater cargo capacity.

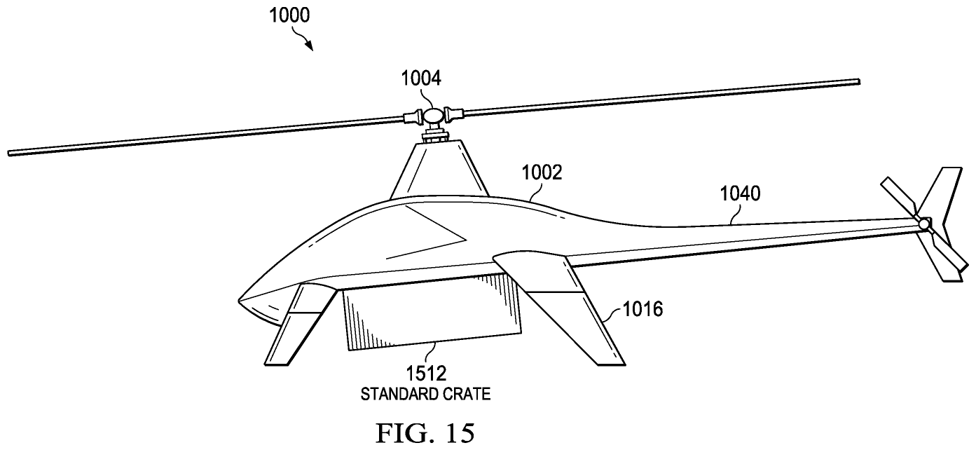

FIG. 15 is an illustration of a large aerodynamic container configuration for rotorcraft 1000. In this example, rotorcraft 1000 has a standard crate 1512 affixed to the bottom of the cargo bay. Standard crate 1512 may be any standard or irregular crate and need not be specifically designed for use with rotorcraft 1000. Standard crate 1512 may be modified or adapted, such as by providing mount points, hooks, quick releases, or other mounting configurations to secure standard crate 1512 to the cargo bay of rotorcraft 1000. In other cases, straps, cables, netting, or other things may be used to secure standard crate 1512 to rotorcraft 1000.

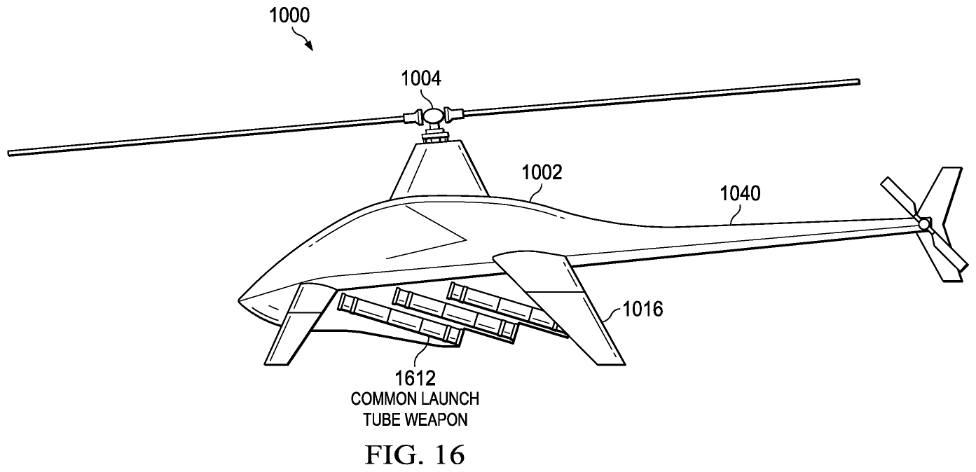

FIG. 16 1000 is a perspective view illustration of an armed configuration for rotorcraft 1000. Rotorcraft 1000 may be adapted for military or police uses and thus may include armaments. In this case, rotorcraft 1000 is provisioned with a common launch tube (CLT) weapon. CLT weapon 1612 includes a plurality of launch tubes, which may carry a plurality of weapons compatible with the CLT system. The CLT system may be carried instead of or in addition to other non-weapon cargo.

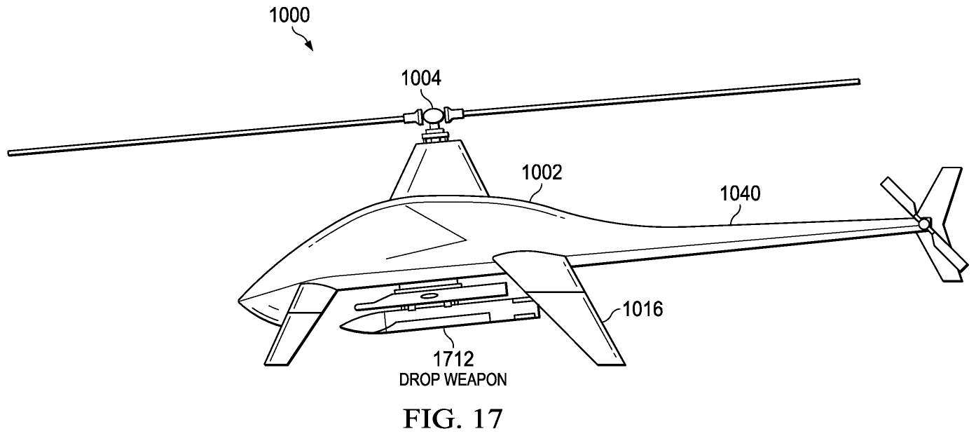

FIG. 17 is a perspective view illustration of an alternative weapon configuration for rotorcraft 1000. In the example of FIG. 17, a drop weapon 1712 is provided. For example, drop weapon 1712 could be a gravity bomb, a guided missile, or other weapon that operates by being dropped from the cargo bay of rotorcraft 1000. As in the example of FIG. 16, this could be for a military or police application for rotorcraft 1000.

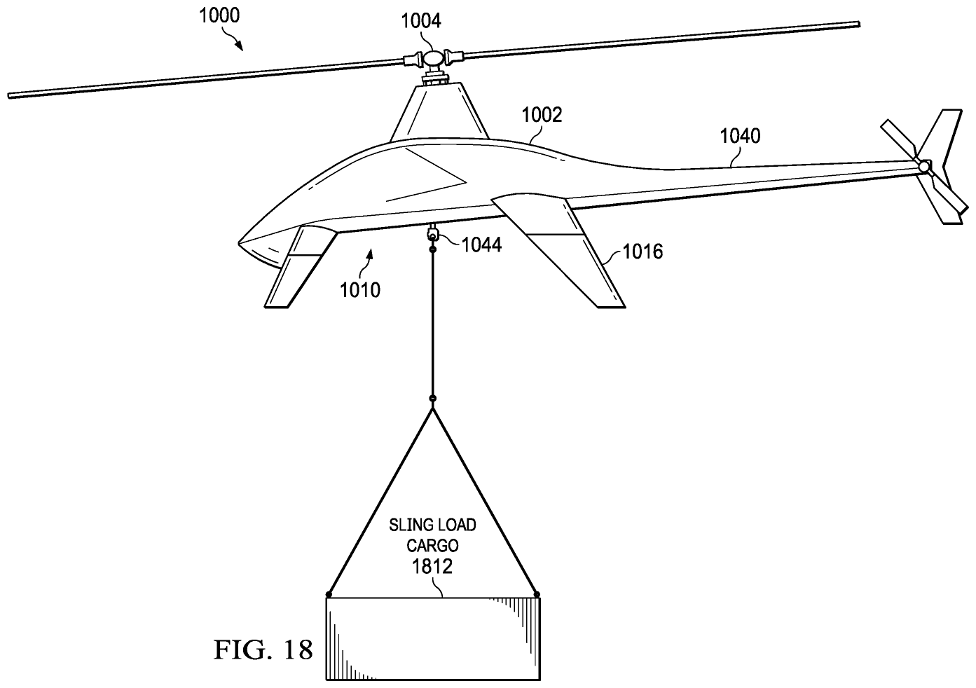

FIG. 18 is a perspective view illustration of a sling load configuration for rotorcraft 1000. In this illustration, sling load cargo 1812 is affixed to rotorcraft 1000 via load hook 1044. Sling load cargo 1812 may be suspended by a cable, a tether, a net, or other configuration. This configuration illustrates that rotorcraft 1000 is able to carry large, irregular, or other cargo that does not fit nicely within its cargo bay 1010.

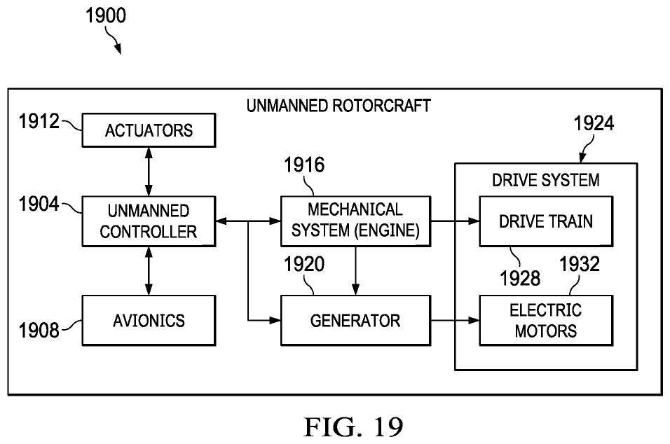

FIG. 19 is a block diagram illustration of selected elements of an unmanned rotorcraft 1900. Unmanned rotorcraft 1900 includes an unmanned controller 1904. An unmanned controller 1904 may be configured for autonomous or semiautonomous configuration. For example, in a semiautonomous configuration, unmanned controller 1904 may receive gross command inputs, which indicate, for example, a direction, an airspeed, an altitude, or other desired functionality. In that case, unmanned controller 1904 may still need to perform calculations to carry out these instructions. In a fully autonomous configuration, unmanned controller 1904 may simply be programmed with a predesignated flight plan, and unmanned controller 1904 may have responsibility for fully carrying out the designated flight plan.

In performing calculations and computations, unmanned controller 1904 may receive inputs from avionics 1908. Avionics 1908 may include various sensors, transducers, and other data that provide unmanned controller 1904 with information about the aircraft, its operating condition, the outside condition, and other factors. This can include traditional avionics, such as roll, pitch, yaw, outside air temperature, rotor speed, temperature sensors, synchro resolvers, and other information that may be useful for unmanned controller 1904 to make decisions about operation of rotorcraft 1900. Unmanned controller 1904 may then use this information to drive actuators 1912, which may be coupled to control surfaces of the aircraft, to control roll, pitch, yaw, altitude, rotor speed, and other factors that affect the desired flight path of the rotorcraft. For example, actuators 1912 may be mechanically and communicatively coupled to a driveshaft, to a collective controller, or to airfoil surfaces.

Unmanned controller 1904 may have access to a mechanical system, such as an engine 1916. Mechanical system 1916 may include, for example, a chemical or petrochemical engine that operates by burning or exhausting fuel. In some cases, mechanical system 1916 may directly drive a drivetrain 1928, which is part of a drive system 1924.

In the same or a different embodiment, at least partial electrical control may be provided. In that case, mechanical system 1916 could provide instantaneous power to a generator 1920, which provides electrical power to electric motors 1932. Electric motors 1932 may also be used to drive rotors and provide power to the aircraft. In some cases, a mechanical drivetrain 1928 may be omitted and the system may be powered directly by electric motors 1932. In other cases, electric motors 1932 may be omitted and the system may be powered purely by a drivetrain 1928. In yet other examples, some mechanical systems may be driven by drivetrain 1928, and others may be driven by electric motors 1932. Furthermore, in some cases, mechanical system 1916 could be omitted, and instead, batteries or other alternative power sources could provide power to generator 1920.

### Design Variations and Ranges

At least one embodiment is disclosed, and variations, combinations, and/or modifications of the embodiment(s) and/or features of the embodiment(s) made by a person having ordinary skill in the art are within the scope of this disclosure. Alternative embodiments that result from combining, integrating, and/or omitting features of the embodiment(s) are also within the scope of this disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, RI, and an upper limit, Ru, is disclosed, any number falling within the range is specifically disclosed. In particular, the following numbers within the range are specifically disclosed: R=RI+k*(Ru-RI), wherein k is a variable ranging from 1 percent to 100 percent with a 1 percent increment, i.e., k is 1 percent, 2 percent, 3 percent, 4 percent, 5 percent, 50 percent, 51 percent, 52 percent, . . . , 95 percent, 96 percent, 95 percent, 98 percent, 99 percent, or 100 percent. Moreover, any numerical range defined by two R numbers as defined in the above is also specifically disclosed. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present invention. Also, the phrases “at least one of A, B, and C” and “A and/or B and/or C” should each be interpreted to include only A, only B, only C, or any combination of A, B, and C.

Although several embodiments have been illustrated and described in detail, numerous other changes, substitutions, variations, alterations, and/or modifications are possible without departing from the spirit and scope of the present invention, as defined by the appended claims. The particular embodiments described herein are illustrative only and may be modified and practiced in different but equivalent manners, as would be apparent to those of ordinary skill in the art having the benefit of the teachings herein. Those of ordinary skill in the art would appreciate that the present disclosure may be readily used as a basis for designing or modifying other embodiments for carrying out the same purposes and/or achieving the same advantages of the embodiments introduced herein. For example, certain embodiments may be implemented using more, less, and/or other components than those described herein. Moreover, in certain embodiments, some components may be implemented separately, consolidated into one or more integrated components, and/or omitted. Similarly, methods associated with certain embodiments may be implemented using more, less, and/or other steps than those described herein, and their steps may be performed in any suitable order.

Numerous other changes, substitutions, variations, alterations, and modifications may be ascertained to one of ordinary skill in the art and it is intended that the present disclosure encompass all such changes, substitutions, variations, alterations, and modifications as falling within the scope of the appended claims.

### Selected Examples

The teachings of the present specification may be understood in terms of various examples, as follows.

There is disclosed in an example, a vertical takeoff and landing (VTOL) aircraft, comprising: a vehicle controller circuit programmed to operate the VTOL aircraft without an onboard human operator; a rotor system; an airframe; and an external cargo coupling to receive an external payload of at least approximately 300 pounds beneath the airframe.

There is further disclosed an example wherein the rotor system is a tandem rotor system.

There is further disclosed an example wherein the rotor system comprises a single main rotor.

There is further disclosed an example wherein the VTOL aircraft has external dimensions to fit within and substantially fill an intermodal shipping container, with the rotor system in a folded configuration.

There is further disclosed an example wherein the intermodal shipping container is a 20-foot-long intermodal shipping container.

There is further disclosed an example wherein the intermodal shipping container is a 40-foot-long intermodal shipping container.

There is further disclosed an example further comprising an aerodynamic cargo bay configured to mount to an underside of the airframe as the external payload.

There is further disclosed an example wherein the aerodynamic cargo bay comprises a carbon fiber exterior.

There is further disclosed an example wherein the aerodynamic cargo bay comprises a lightweight metal exterior.

There is further disclosed an example wherein the aerodynamic cargo bay comprises a composite exterior.

There is further disclosed an example wherein an underside of the airframe comprises a cargo hook for a sling load.

There is further disclosed an example wherein an underside of the airframe comprises mounting means to receive a cargo crate not designed for specific use with the VTOL aircraft.

There is further disclosed an example further comprising a cargo sled to provide the external payload.

There is further disclosed an example wherein the cargo sled comprises open or semi-open sides.

There is further disclosed an example further comprising flexible netting to secure the open or semi-open sides of the cargo sled.

There is further disclosed an example wherein the cargo sled comprises a rear access door or tailgate.

There is further disclosed an example further comprising means to raise and lower the cargo sled from an underside of the airframe.

There is further disclosed an example further comprising a chemical-mechanical power plant for the rotor system.

There is further disclosed an example further comprising one or more electric motors to drive the rotor system.

There is further disclosed an example further comprising a hybrid-electric power plant for the one or more electric motors.

There is further disclosed an example further comprising a battery or battery bank to power the one or more electric motors.

There is further disclosed an example of an unmanned rotorcraft, comprising: an airframe; a primary drive system comprising tandem rotors; a power plant to power the primary drive system; a controller to operate the unmanned rotorcraft without a human operator onboard; an external cargo adapter to receive an external payload on an underside of the unmanned rotorcraft; and wherein the unmanned rotorcraft has dimensions to fit within and substantially fill an ISO intermodal container with the tandem rotors removed or folded.

There is further disclosed an example wherein the ISO intermodal container is a 20-foot-long intermodal container.

There is further disclosed an example wherein the ISO intermodal container is a 40-foot-long intermodal container.

There is further disclosed an example further comprising an aerodynamic cargo bay configured to mount to an underside of the airframe as the external payload.

There is further disclosed an example wherein the aerodynamic cargo bay comprises a carbon fiber exterior.

There is further disclosed an example wherein the aerodynamic cargo bay comprises a lightweight metal exterior.

There is further disclosed an example wherein the aerodynamic cargo bay comprises a composite exterior.

There is further disclosed an example wherein an underside of the airframe comprises a cargo hook for a sling load.

There is further disclosed an example wherein an underside of the airframe comprises mounting means to receive a cargo crate not designed for specific use with the unmanned rotorcraft.

There is further disclosed an example further comprising a cargo sled to provide the external payload.

There is further disclosed an example wherein the cargo sled comprises open or semi-open sides.

There is further disclosed an example further comprising flexible netting to secure the open or semi-open sides of the cargo sled.

There is further disclosed an example wherein the cargo sled comprises a rear access door or tailgate.

There is further disclosed an example further comprising means to raise and lower the cargo sled from an underside of the airframe.

There is further disclosed an example further comprising a chemical-mechanical power plant.

There is further disclosed an example further comprising a hybrid-electric power plant for one or more electric motors.

There is further disclosed an example further comprising a battery or battery bank to power one or more electric motors.

There is further disclosed an example of an unmanned rotorcraft with a cargo capacity of at least approximately 300 pounds, comprising: an airframe with a tail and rear stabilizer; a drive system comprising a single primary rotor for vertical takeoff and landing (VTOL) operation; an electronic controller circuit programmed to provide unmanned operation; and an external cargo mount for carrying an external payload.

There is further disclosed an example wherein the unmanned rotorcraft has external dimensions to fit within and substantially fill an intermodal shipping container, exclusive of a fully extended drive system.

There is further disclosed an example wherein the intermodal shipping container is a 20-foot-long intermodal container.

There is further disclosed an example wherein the intermodal shipping container is a 40-foot-long intermodal container.

There is further disclosed an example further comprising an aerodynamic cargo bay configured to mount to an underside of the airframe as the external payload.

There is further disclosed an example wherein the aerodynamic cargo bay comprises a carbon fiber exterior.

There is further disclosed an example wherein the aerodynamic cargo bay comprises a lightweight metal exterior.

There is further disclosed an example wherein the aerodynamic cargo bay comprises a composite exterior.

There is further disclosed an example wherein an underside of the airframe comprises a cargo hook for a sling load.

There is further disclosed an example wherein an underside of the airframe comprises mounting means to receive a cargo crate not designed for specific use with the unmanned rotorcraft.

There is further disclosed an example further comprising a cargo sled to provide the external payload.

There is further disclosed an example wherein the cargo sled comprises open or semi-open sides.

There is further disclosed an example further comprising flexible netting to secure the open or semi-open sides of the cargo sled.

There is further disclosed an example wherein the cargo sled comprises a rear access door or tailgate.

There is further disclosed an example further comprising means to raise and lower the cargo sled from an underside of the airframe.

There is further disclosed an example further comprising a chemical-mechanical power plant.

There is further disclosed an example further comprising a hybrid-electric power plant for one or more electric motors.

There is further disclosed an example further comprising a battery or battery bank to power one or more electric motors.

1. A vertical takeoff and landing (VTOL) aircraft, comprising:
a vehicle controller circuit programmed to operate the VTOL aircraft without an onboard human operator;
a rotor system;
an airframe; and
an external cargo coupling to receive an external payload of at least approximately 300 pounds beneath the airframe.

2. The VTOL aircraft of claim 1, wherein the rotor system is a tandem rotor system.

3. The VTOL aircraft of claim 2, further comprising low-profile armatures to connect the tandem rotor system to the airframe.

4. The VTOL aircraft of claim 1, wherein the rotor system comprises a single main rotor.

5. The VTOL aircraft of claim 1, wherein the VTOL aircraft has external dimensions to fit within and substantially fill an intermodal shipping container, with the rotor system in a folded configuration.

6. The VTOL aircraft of claim 4, wherein the intermodal shipping container is a 20-foot-long intermodal shipping container.

7. The VTOL aircraft of claim 4, wherein the intermodal shipping container is a 40-foot-long intermodal shipping container.

8. The VTOL aircraft of claim 1, further comprising an aerodynamic cargo bay configured to mount to an underside of the airframe as the external payload.

9. The VTOL aircraft of claim 8, wherein the aerodynamic cargo bay comprises a carbon fiber, composite, or lightweight metal exterior.

10. The VTOL aircraft of claim 1, wherein an underside of the airframe comprises a cargo hook for a sling load.

11. The VTOL aircraft of claim 1, wherein an underside of the airframe comprises mounting means to receive a cargo crate not designed for specific use with the VTOL aircraft.

12. The VTOL aircraft of claim 1, further comprising a cargo sled with open or semi-open sides to provide the external payload.

13. The VTOL aircraft of claim 12, wherein the cargo sled comprises a rear access door or tailgate.

14. An unmanned rotorcraft, comprising:
an airframe;
a primary drive system comprising tandem rotors;
a power plant to power the primary drive system;
a controller to operate the unmanned rotorcraft without a human operator onboard;
an external cargo adapter to receive an external payload on an underside of the unmanned rotorcraft; and
wherein the unmanned rotorcraft has dimensions to fit within and substantially fill an ISO intermodal container with the tandem rotors removed or folded.

15. The unmanned rotorcraft of claim 13, further comprising a chemical-mechanical power plant.

16. The unmanned rotorcraft of claim 13, further comprising a hybrid-electric power plant for one or more electric motors.

17. The unmanned rotorcraft of claim 13, further comprising a battery or battery bank to power one or more electric motors.

18. An unmanned rotorcraft with a cargo capacity of at least approximately 300 pounds, comprising:
an airframe with a tail and rear stabilizer;
a drive system comprising a single primary rotor for vertical takeoff and landing (VTOL) operation;
an electronic controller circuit programmed to provide unmanned operation; and
an external cargo mount for carrying an external payload.

19. The unmanned rotorcraft of claim 17, wherein the unmanned rotorcraft has external dimensions to fit within and substantially fill an intermodal shipping container, exclusive of a fully extended drive system.

20. The unmanned rotorcraft of claim 17, further comprising an aerodynamic cargo bay configured to mount to an underside of the airframe as the external payload.

21. The unmanned rotorcraft of claim 17, wherein an underside of the airframe comprises mounting means to receive a cargo crate not designed for specific use with the unmanned rotorcraft.
